(19) United States
(12) Patent Application Publication
(10) Pub. No.: US 2009/0296980 A1
(43) Pub. Date: Dec. 3, 2009

(54) System and Method for Producing a Geometric Model of the Auditory Canal

(76) Inventor: Steven Yi, Vienna, VA (US)

Correspondence Address: STEVEN L. NICHOLS;RADER, FISHMAN & GRAUER PLLC, 10653 S. RIVER FRONT PARKWAY, SUITE 150, SOUTH JORDAN, UT, 84095, US

(21) Appl. No.: 12/131,264

(22) Filed: Jun. 2, 2008

(51) Int. Cl. G06K 9/00

(52) U.S. Cl. 382/100

(57) ABSTRACT

A system creating a three-dimensional model of a confined space includes a balloon that is inflated to make contact with the confined space, the balloon's interior surface having surface features; and a sensor configured to make measurements of the interior surface of the balloon, the measurements being manipulated to form three-dimensional model of confined space. A method of creating a three-dimensional model of a confined space includes making a series of 360 degree panoramic images of the confined space using a single moving camera; and manipulating the 360 degree panoramic images to create the three-dimensional model.

### BACKGROUND

To protect and improve hearing, it is often desirable to place ear plugs, ear phones, or hearing aids into the auditory canal. For the best performance of these auditory devices, it is important to have a proper fit between the patient's auditory canal and the auditory device. The geometry of the auditory canal varies between individuals and can change with age. Thus, to obtain a proper fit between the patient's auditory canal and the auditory device, a measurement or model of the patient's auditory canal is made.

Ordinarily, the measurement or model of the patient's auditory canal is obtained by making a physical impression of the interior of a patient's ear. Currently, making custom auditory equipment from a physical impression is an expensive and time consuming process. To make the physical impression, a resin is poured into the patient's auditory canal. This can be an uncomfortable process for many patients and can distort the internal structure of the auditory canal.

After the resin cures, it is removed and shipped to a manufacturer, where the auditory device is custom-made by skilled technicians using a number of manual operations. The quality and consistency of the fit varies significantly with each technician's skill level. Further, this manual process is not adapted to precision production techniques such as computer aided drafting/computer aided manufacturing (CAD/CAM). About one to three weeks later, the completed auditory equipment is ready to be shipped back to the patient for fitting and testing.

At each step in the process, there are opportunities for errors that result in a poor fit between the patient's auditory canal and the auditory device. The expense associated with the process of making a custom-fit auditory device discourages many individuals who would benefit from obtaining one. Additionally, as a result of a poor fit, approximately one-third of custom auditory devices are returned and numerous other auditory devices, once obtained, are simply neglected and not used.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a partial cross-sectional diagram of a human ear, according to one embodiment of principles described herein.

FIG. 2 is a partial cross-sectional diagram of a human ear with an illustrative intra-ear camera inserted into the auditory canal, according to one embodiment of principles described herein.

FIG. 3 is a cross-sectional diagram of an illustrative intra-ear camera, according to one embodiment of principles described herein.

FIG. 4 is a cross-sectional diagram of a human ear showing an illustrative imaging probe making three-dimensional measurements the auditory canal, according to one embodiment of principles described herein.

FIG. 5 is a diagram showing one illustrative method for manipulating a series of measurements made by an intra-ear camera to create a three-dimensional measurement, according to one embodiment of principles described herein.

FIG. 6 is a diagram showing one illustrative example of an error minimization technique used during three-dimensional point reconstructions from two dimensional images, according to one embodiment of principles described herein.

FIG. 7 is a flowchart showing one illustrative method for acquiring data from an intra-ear camera, according to one embodiment of principles described herein.

FIG. 8 is a flowchart showing one illustrative method for generating three-dimensional images from data acquired by an intra-ear camera, according to one embodiment of principles described herein.

FIG. 9 is a flowchart showing one illustrative method for constructing and utilizing a three-dimensional model from a series of three-dimensional images, according to one embodiment of principles described herein.

Throughout the drawings, identical reference numbers designate similar, but not necessarily identical, elements.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

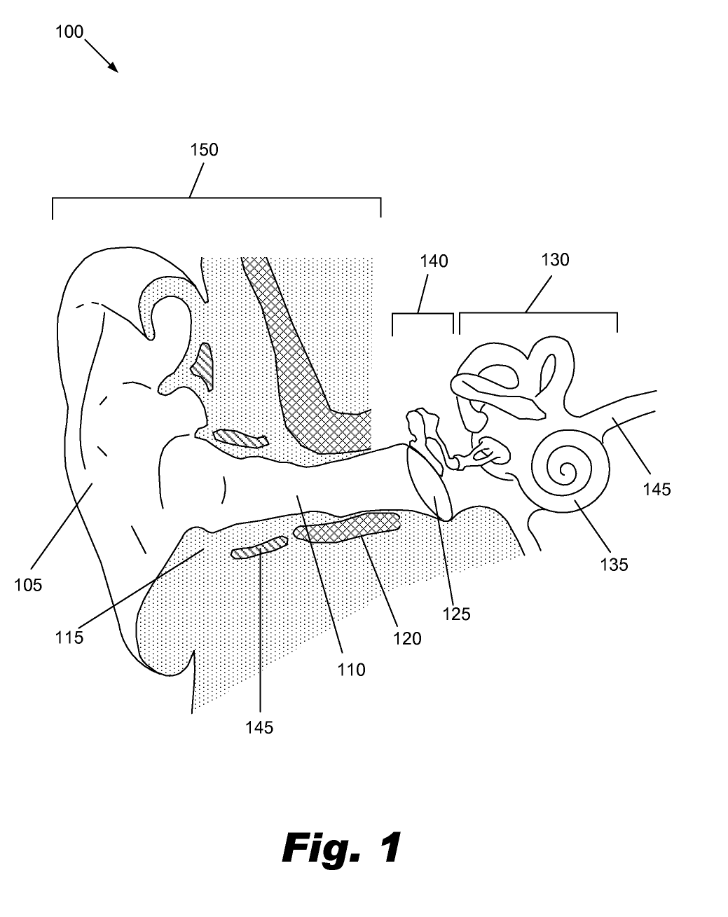

FIG. 1 is a partial cross-sectional diagram of a human ear (100). The human ear (100) comprises the outer ear (150), the middle ear (140), and the inner ear (130). The outer ear consists of the pinna (105), the auditory canal (110), and the outer portion of the tympanic membrane (125). In humans, the pinna (105) is a fleshy outer flap which serves the purpose of directing sound waves into the auditory canal (110). At the terminal end of the auditory canal (110), the tympanic membrane (125) vibrates in response to the sound waves.

The middle ear (140) consists of three bony structures called ossicles. These ossicles filter and amplify the sound waves received by the tympanic membrane (125) and conduct the sound waves into the inner ear (130). A primary component of the inner ear is the cochlea (135). When sound strikes the tympanic membrane (125), the movement is transferred through the ossicles to a fluid filled duct within the cochlea (135). The motion of the fluid inside the cochlea (125) stimulates hair cells, which convert this motion into nerve impulses. These nerve impulses pass through the auditory nerve (145) to the brain.

In some cases, it can be desirable to insert an auditory device into the auditory canal in order to alter or generate sound waves striking the tympanic membrane (125). By way of example and not limitation, an auditory device may perform one or more of the following functions: blocking, filtering, generating, or amplification of sound. For example, speakers which are inserted into the auditory canal (110) use significantly less energy and are more effective in directing sound waves into the middle ear. These speakers may be connected to a variety of equipment including cell phones, personal digital assistants (PDAs), music players, and other communication devices.

In some individuals, particularly the elderly, the function of various components within the ear can be compromised, resulting in hearing loss. For example, conductive hearing loss results from a failure to efficiently conduct and/or amplify sound waves in the outer ear, the tympanic membrane, or the middle ear. Hearing loss can also be caused by sensorineural damage to the delicate structures inside the cochlea (135). Sensorineural hearing loss can result, for example, from noise, trauma, and infection. In many instances, amplifying and filtering external sounds can compensate for hearing loss, particularly conductive hearing loss. This is often done by inserting a hearing aid into the auditory canal.

Effective hearing aids require an effective fit. An effective fit requires that a device fit comfortably in the auditory canal (110). A hearing aid is most effective when the hearing aid blocks any external noise and only allows the modified and amplified sound waves to be conducted to the tympanic membrane (125).

Typically hearing aids are made of relatively hard material which forms a shell containing the required electronics and a battery. The shell must achieve a relatively good fit to be comfortable and effective. Earpieces that are too small fall out, and earpieces are uncomfortably tight when they are too large.

One of the primary challenges in creating earpieces with an effective fit is making an accurate measurement of the auditory canal (110) in which the earpiece will be placed. The auditory canal geometry can vary from individual to individual. Particularly in elderly individuals, the auditory canal can have several sharp turns and unique geometry. Additionally, the auditory canal is made up of a variety of tissue types including hard bony tissues (120), soft tissues (115), and cartilaginous tissues (145). Each of these tissues react differently to applied forces, making it important to accommodate each of these tissue types to achieve an effective fit

The current method of making custom-fit earpieces for hearing aids is a highly labor-intensive and manual process. The quality control of the fit and performance of the hearing aids is difficult. The custom-fit process starts with taking an ear impression of the patient's ear at the office of an audiologist or dispenser. The process of taking this physical ear impression can be very uncomfortable for many patients. A resin, typically silicon based, is injected into the patent's auditory canal, allowed to cure, and then removed. This forms an impression of the auditory canal. The impression procedure itself distorts the geometry of the auditory canal and may cause deformation affecting the measurement accuracy or quality of the resulting hearing aid. The impression is then shipped to the manufacturer's laboratory. The process of shipping an ear impression to the manufacturing facility often results in an inaccurate fit of the auditory device due to the impression material (which is usually silicone and always malleable) being shaken and handled roughly in transit to the manufacturing facility, resulting in an inaccurate impression of the patient's ear when manufactured.

Upon receipt by the manufacturer, the physical impression is cleaned and sanitized, which provides another opportunity for distortion. Then, a trained technician “sculpts” the impression by carving away sections that might fit too snugly or interfere with sound transmission. Depending on the skills of the technician, this is another opportunity for considerable error. A hard shell casing is created from this altered impression. In many cases, the impression and its derivative molds is destroyed during the manufacturing process. The hard shell casing houses the electronics that are customized to the patient's unique hearing loss situation. About one to three weeks after the impression is made, the completed hearing aid is ready to be shipped back to the facility that ordered it and then installed in the patient's ear and tested for fit and function.

However, at the conclusion of this laborious and time-consuming process, almost one-third of custom hearing aids needs to be returned, the majority of them because of ineffective fit between the hard shell of the hearing aid and the auditory canal of the patient. In the event of the loss or destruction of the auditory device, a new impression must be made and similar delay of one to three weeks occurs.

This manual fabrication process also suffers major drawbacks from a manufacturer's viewpoint. A few of these drawbacks include fabrication speed, delivery delay, quality assurance, and training. Because of the manual and lengthy process required to produce a custom-fit hearing aid, the process is not scalable for mass production. Transportation delays caused by the necessity of shipping the physical impressions from the dispensers to the manufacturing facility and then shipping the completed hearing aid back to the dispenser causes additional undesirable delay. Lack of consistent quality causes high levels of returns and remakes. Additionally, there is a requirement for trained and skilled workers to produce consistent quality hearing aids. The training and employment of these workers is a significant burden on the manufacturer.

Obtaining a correct impression of the ear is critical for the successful manufacturing of custom-fit hearing aids and other types of earpieces. A significant savings in time, reduction in cost, and increase in accuracy can be achieved by making three-dimensional measurements of the interior of the patient's auditory canal and processing these three-dimensional measurements to create a three-dimensional digital model of the auditory canal. By creating a three-dimensional digital model of the auditory canal there is no need to make a physical impression of the auditory canal, physically ship the impression, or manually sculpt the impression. Additionally, the resulting three-dimensional digital model is well suited for mass production. The three-dimensional digital model can be computer manipulated using proven statistical models to minimize error and produce consistent quality. The digital ear impression data can be directly shipped to the manufacturer's lab via the Internet. This can dramatically reduce the delivery time and cost. Additionally, an accurate three-dimensional geometry also provides the ability to better optimize the interior volume of the hearing aid to allow additional electronics to be added. The manufacturer can use computer aided drafting/computer aided manufacturing (CAD/CAM) technologies to rapidly generate mass customized products that are individually tailored to specific individuals. It can reduce the cost and increase the availability of the product to the general population. Further, the turnaround time for producing a custom-fit hearing aid can be reduced from several weeks to same-day production.

However, making three-dimensional measurements of the interior of the auditory canal (110) can be challenging. As mentioned above, the geometry of the auditory canal (110) can vary widely from individual to individual. Further, the interior of the auditory canal lacks rich features that allow for image registration. Typically, the skin surface inside the auditory canal (110) has inconsistent feature patterns. These patterns may include various pores, hair, or wax accumulations. Additionally, to create an accurate three-dimensional model there must be a method of creating an absolute dimension or calibrating the scale of the three-dimensional measurements. Not only are these features inadequate for image registration and scaling, the features can produce false measurements or obscure the surface of the ear canal. For example, a wax accumulation could be incorrectly viewed as a geometric variation of the surface of the auditory canal.

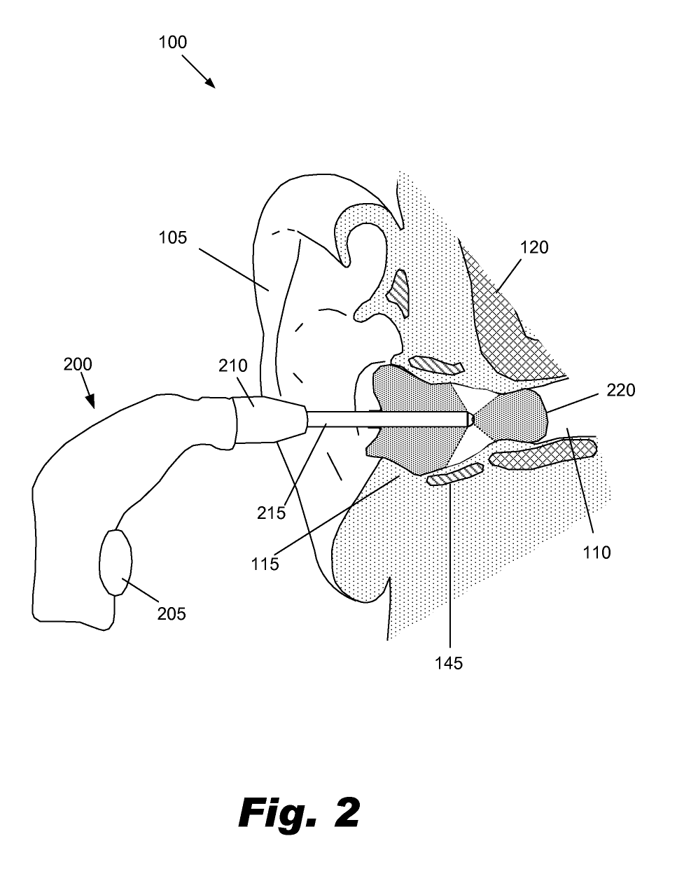

FIG. 2 is a partial cross-sectional diagram of a human ear (100) with an illustrative intra-ear camera (200) inserted into the auditory canal. In this illustrative embodiment, the intra-ear camera (200) comprises an imaging probe (215), an imaging sensor (210), and an air pump (205). As discussed above, attempting to make quantitative measurements of the auditory canal (110) based on its skin surface can be difficult. Instead of making measurements based on the skin surface of the auditory canal (110), the tip of the imaging probe (215) is enclosed in a balloon (220). According to one exemplary embodiment, the balloon (220) is a disposable miniature air balloon. The balloon may be made of a variety of suitable materials including latex, polychloroprene, polyurethane, nylon elastomer, etc. According to one exemplary embodiment, the balloon material is very flexible and can stretch its volume over 600%. The balloon (220) has an interior surface that has rich features which allow image registration between successive measurements. By way of example and not limitation, the rich features could include dots, crosses, grids, rainbow spectrum color patterns/rings, or other suitable patterns.

The balloon (220) is inflated by means of an air pump (205) which is located on the handle of the intra-ear camera (200). The balloon (220) is inflated using the air pump (205) until the outer surface of the balloon achieves the desired contact with the inner surface of the auditory canal (110). The interior pressure of the balloon (220) can be varied to achieve the desired level of detail in the measurements. For example, at low pressures, the balloon (220) may not fully touch the skin in concave sections of the auditory canal (110). The internal pressure of the balloon could be increased until the balloon (220) makes the desired amount of surface contact with the auditory canal.

The imaging probe (215) passes into the balloon (220) and can be moved within the interior of the balloon (220). The imaging probe (215) illuminates the interior of the balloon (220) and admits light from the interior surface of the balloon back into the imaging probe (215). According to one exemplary embodiment, the field of view of the imaging probe (215) encompasses 360 degrees. This light is focused onto the imaging sensor (210), which converts the images into data signals which are stored and/or transmitted by the intra-ear camera (200).

The use of the balloon (220) provides a number of benefits. First, the balloon (220) complies with the auditory canal shape to allow a more accurate three-dimensional measurement. The feature rich interior surface of the balloon (220) provides for more precise image registration during processing of the measurement data. The use of a balloon (220) keeps the tip of the imaging probe (215) free from earwax, fingerprints, or other types of contamination, thereby ensuring image quality and patient health. Without using the balloon (220), the cleanness of the ear, scattered hair on the ear surface, and lack of salient features could make the three-dimensional measurements impractical.

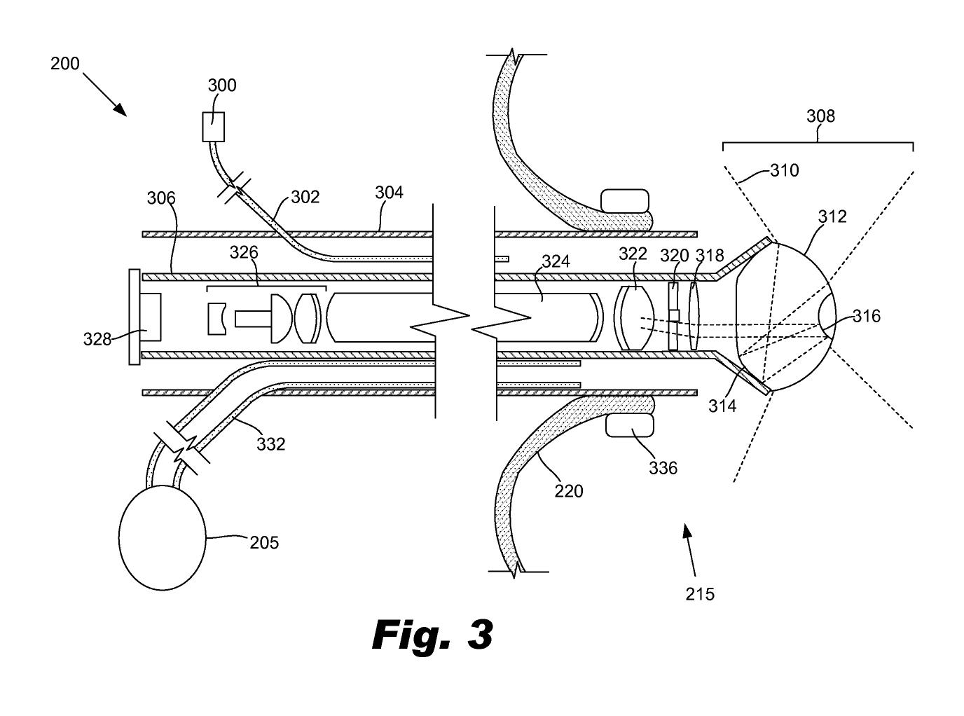

FIG. 3 is a cross-sectional diagram of selected components within an illustrative intra-ear camera (200). According to one exemplary embodiment, the intra-ear camera (200) enters the balloon (220) through a compliant ring (336). The compliant ring (336) provides an airtight seal between the balloon (220) and the outer tube (304) of the intra-ear camera (200). According to one exemplary embodiment, the air pump (205) is attached to an air tube (332) which passes into the imaging probe (215). The air pump (205) is used to force pressurized air through the air tube (332) to inflate the balloon (220). A number of additional components could be utilized within the intra-ear camera (200) to achieve the desired pneumatic control of the balloon. By way of example and not limitation, these components may include a regulator, various flow control valves, or other pneumatic devices.

A light source (300) can be used to generate light to illuminate the interior of the balloon (220). By way of example and not limitation, light source (300) may be a light emitting diode, conventional filament, xenon bulb, fluorescent tube, or other appropriate light source. According to one exemplary embodiment, a light source (300) comprises one or more light emitting diodes. Light emitting diodes have the advantages of low power consumption, small size, and efficient conversion of electrical energy into optical energy. Light emitting diodes may be especially suitable for handheld devices. Light generated by the light source (300) can be introduced into the interior of the balloon (220) in a variety of ways. According to one exemplary embodiment, a light guide (302) may conduct optical energy from the light source (300) into the imaging probe (215). The light guide (302) may extend through the imaging probe (215) and into the interior of the balloon (220) or may terminate within the imaging probe (215).

The interior of the balloon is imaged through a series of optical elements (334, 318, 320, 322, 324, 326) onto an image sensor (328). According to one exemplary embodiment, light is initially gathered from the surroundings through an omni-lens (334). The omni-lens (334) comprises a refractive surface (312), a first reflective surface (314), and a second reflective surface (316). The omni-lens (334) is rotationally symmetric about its center line and provides 3600 panoramic view of the view (308). Various light rays (310) are indicated by dashed lines and illustrate the panoramic field of view (308) and the subsequent reflections of the captured light within the various optical components. The light rays (310) are for illustrative purposes only and are not meant to quantitatively define the performance or other parameters of the system.

A light ray (310) entering the imaging probe (215) first encounters the refractive surface (312) of the omni-lens (334). The light ray (310) continues through the omni-lens (334) until it strikes the first reflective surface (314) and is directed toward the second reflective service (316). After striking the second reflective surface (316), the light ray (310) is directed out of the omni-lens (334) and into a relay lens (318). Advantages of the omni-lens (334) include its compact size, large field of view, and its ability to manipulate the received light through interactions with three successive optical surfaces. The omni-lens (334) and other optical components are supported by an inner tube (306). After passing through the relay lens (318), the light ray passes through an iris (320), objective lens (222), and a rod lens (324). The rod lens (324) conveys the light rays through the length of the enclosure tube (306) to the coupling optics (326). The coupling optics (326) image the light ray onto an imaging sensor (328). As discussed above, the imaging sensor (328) converts the optical energy into electrical data signals which are then transmitted and manipulated to form three-dimensional measurements of the auditory canal (110, FIG. 1).

Some advantages of this optical system include its compact design, even resolution, protected optics, minimal cost, and robust alignment. According to one exemplary embodiment, the total diameter of the imaging probe is less than 3 mm. The probe makes simultaneous measurements of a 360 degree field-of-view for simultaneous imaging of the auditory canal. The enclosed design for the optics and illumination protects the components from rough handling and contamination.

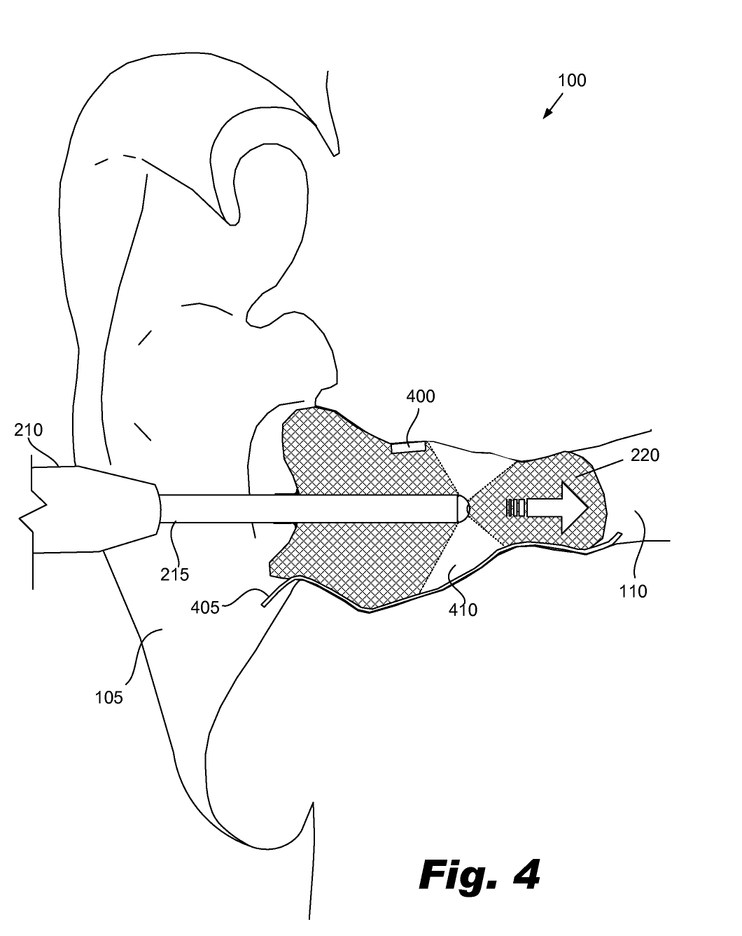

FIG. 4 is a cross-sectional diagram of a human ear (100) showing an illustrative imaging probe (215) making three-dimensional measurements the auditory canal (110). FIG. 4 illustrates additional components utilized in making three-dimensional measurements according to one illustrative embodiment of the intra-ear camera (200, FIG. 2). These components include a noncompliant calibration pattern (400) placed on the interior surface of the balloon (220). This noncompliant calibration pattern (400) has known dimensions and is used to determine the absolute scaling of the three-dimensional model. A variety of methods could be used to construct the noncompliant calibration pattern (400). According to one exemplary embodiment, noncompliant ink could be used to print the noncompliant calibration pattern (400) on the balloon's interior surface. In another embodiment, pre-made patches could be glued onto the balloon's interior surface.

A flexible vent pipe (405) is used during the inflation of the balloon (220) to allow air trapped in the auditory canal (110) to escape as the balloon inflates. This prevents uncomfortable pressure in the auditory canal as a result of compression of trapped air by the inflating balloon (220). The flexible vent pipe (405) is removed once the balloon (220) is fully inflated and the desired amount of surface contact between the balloon (220) and the auditory canal (110) is achieved.

Image sequences are acquired as the imaging probe (215) moves inside the balloon (220). In most cases, the primary motion of the imaging probe (215) within the balloon is in an axial direction as shown by the arrow in FIG. 4. A number of sequential images are obtained along the desired portion of the auditory canal (110). These sequential images capture the panoramic field of view (410) and include images of the noncompliant calibration pattern (400).

According to one exemplary embodiment, the three-dimensional model of the auditory canal will be generated using shape from motion (SFM) techniques in which a single moving camera is used to create a three-dimensional stereo image. These three-dimensional stereo images are registered and merged to form the three-dimensional digital model.

In some circumstances, it may be desirable to image external portions of the ear. According to one exemplary embodiment, a different balloon design which easily complies with the external ear shape could be used in conjunction with the intra-ear camera to make the measurements of the external portions of the ear. The process of acquiring images from which a three-dimensional digital model can be constructed would then be substantially the same as that used in making measurements of the auditory canal (110).

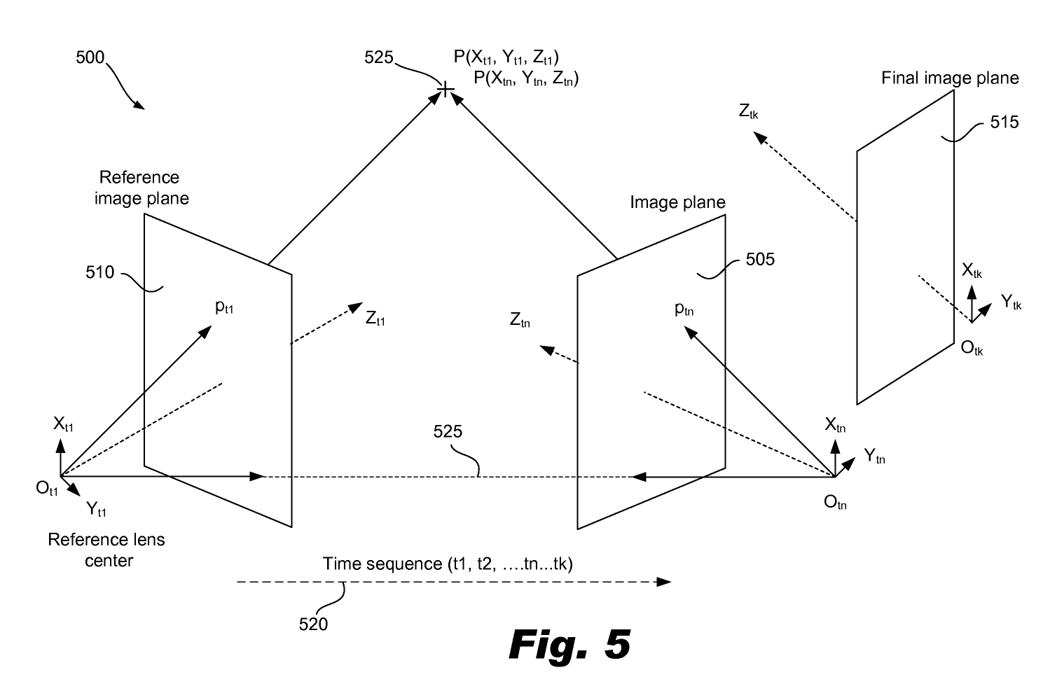

FIG. 5 is a diagram showing one illustrative shape from motion (SFM) algorithm for estimating the camera's motion and the three-dimensional locations of a tracked feature. Ideally, tracked features have high intensity variation in both x and y dimensions. These features can be further broken down into a number of discrete feature points. These feature points are used to recover the camera's motion and the three-dimensional locations of the tracked features by minimizing the error between the tracked point locations and the image locations predicted by the shape and motion estimates. Six degrees-of-freedom (DOF) for each image and three-dimensional position for each tracked feature point are calculated, resulting in a total number of estimated parameters of 6f+3p, where f is the number of images and p is the number of points.

In the following discussion, it is assumed that m images are acquired and that there are n feature points tracked. The lens center of the intra-ear camera is defined by origin O at times t1 through tn. The lens center is a theoretical point at which light rays passing through the optical system converge without modification to the light path. Let Pᵢ (Xᵢ, Yᵢ, Zᵢ) be the three-dimensional location of a feature point i_{ε}{1, . . . , n}, and pᵢⱼ(xᵢⱼ, yᵢⱼ) (where j_{ε}{1, . . . , n}) be its image. For example, at time t1 the lens center is at origin Oₜ₁. Origin Oₜ₁ is defined by a three-dimensional axis having an x-axis defined as a vector Xₜ₁, a y-axis defined by a vector Yₜ₁, and a z-axis defined by vector Zₜ₁. A reference image plane (510) is defined as plane perpendicular to vector Zₜ₁. The location of feature point (525) is quantified as a vector pₜ₁, which extends from the origin Oₜ₁ to the feature point (525) or reference plane (510). A number of feature points (525) could be selected from any given image.

As the camera moves along a path (520), a time sequence of images is acquired by the intra-ear camera. At time tn, the lens center is at origin Oₜₙ and the direction of the feature point (525) is defined by vector pₜₙ. The distance between Oₜ₁ and Oₜₙ is the baseline distance (525) for the measurements made at time t1 and tn. The last measurement in the time sequence is made with the lens center at Oₜₖ, and a final image plane (515) is defined by the Zₜₖ vector originating at the origin Oₜₖ.

Let camera position j be represented by the rotation Rⱼ and translation Tⱼ. Let π: R₃→R₂ be the projection which gives the two-dimensional image location for a three-dimensional point, determined by imaging sensor calibration. To recover the camera motion and structure parameter, the Levenberg-Marquardt (LM) algorithm can be used, which iteratively adjusts the unknown shape and motion parameters {pᵢⱼ} and {Rⱼ, Tⱼ} to minimize the weighted square distance between the predicted and observed feature coordinates:

σ=Σ∥pᵢⱼ−π(RⱼPᵢ+Tⱼ∥² Eq. 1

where the sum is over all i, j such that point i was observed in image j.

While a three-dimensional scene can be theoretically constructed from any image pairs, due to the errors from the camera pose estimation and feature tracking, image pairs with small baseline distances will be much more sensitive to noise, resulting in unreliable three-dimensional reconstruction. In fact, given the same errors in camera pose estimation, bigger baselines lead to smaller three-dimensional reconstruction errors.

According to one exemplary embodiment, only image pairs with large baseline distances are used for reconstructing three-dimensional images, taking full advantage of stereo formation and high resolution three-dimensional data. In embodiments which track features at video rate (30 frames per second), this approach avoids mistracking features and reduces errors of camera pose estimation. By way of example and not limitation, a large baseline distance may be defined based on time sequence and feature disparity. If the time sequence gap and feature disparities of an image pair are greater than certain thresholds, this image pair will be perceived as having a large baseline distance (525).

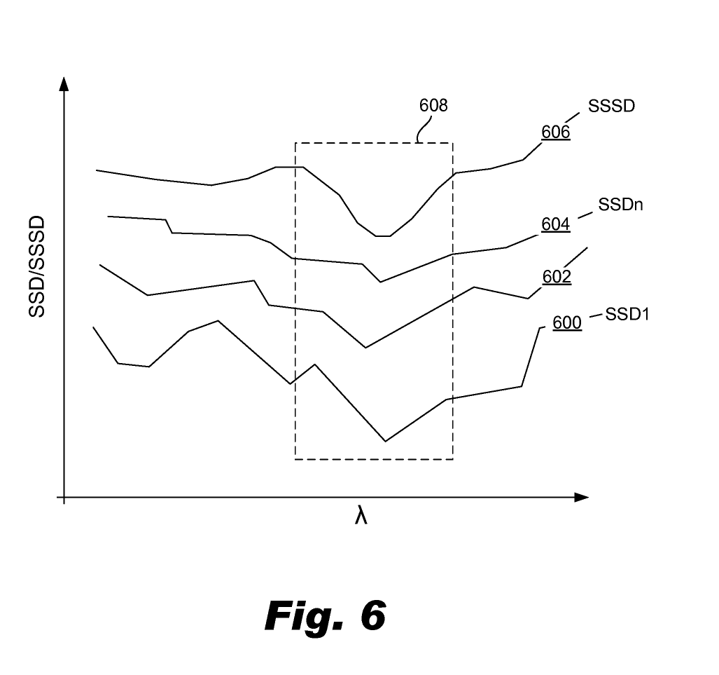

FIG. 6 is a diagram showing one illustrative method for improving reliability and resolution in three-dimensional point reconstruction. Instead of using single image pairs for a three-dimensional point reconstruction, multiple image pairs of different baseline distances (all satisfying the “large baseline distance” requirement as defined above) are combined. As shown in FIG. 6, this multi-frame approach allows the reduction of noise and further improves the accuracy of the three-dimensional image. According to one embodiment, the multi-frame three-dimensional reconstruction is based on the following equation:

$$\frac{Δ d}{B} = \frac{f}{Z} = f * \frac{1}{Z} = λ \qquad Eq . 2$$

Where:

Δd=disparity

B=baseline length

Z=distance

f=focal length

λ=ratio

This equation indicates that for a particular data point in the image, the disparity Δd divided by the baseline length B is constant since there is only one distance Z for that point (f is the focal length). If any evidence or measure of matching for the same point is represented with respect to λ, it should consistently show a good indication only at the single correct value of [symbol] independent of B. Therefore, if we fuse or add such measures from a stereo of multiple baselines (or multi-frames) into a single measure, we can expect that it will indicate a unique match position. This addition creates a smooth curve and reduces undesirable noise.

The Sum of Squared Differences (SSDs) over a small window is one of the simplest and most effective measures of image matching. The curves SSD1 to SSDn in FIG. 6 show typical curves (600, 602, 604) of SSD values with respect to λ for individual stereo image pairs (SSD1 through SSDn). Note that these SSD functions have the same minimum position that corresponds to the true depth. These SSD functions (600, 602, 604) are added over all stereo pairs to produce the sum of SSDs, which we call SSSD-in-inverse-distance (606). The SSSD-in-inverse-distance (606) has a more clear and unambiguous minimum (608). According to one exemplary embodiment, this technique may allow the three-dimensional location of the features on the interior surface of the balloon to be calculated within 100 microns of the true value.

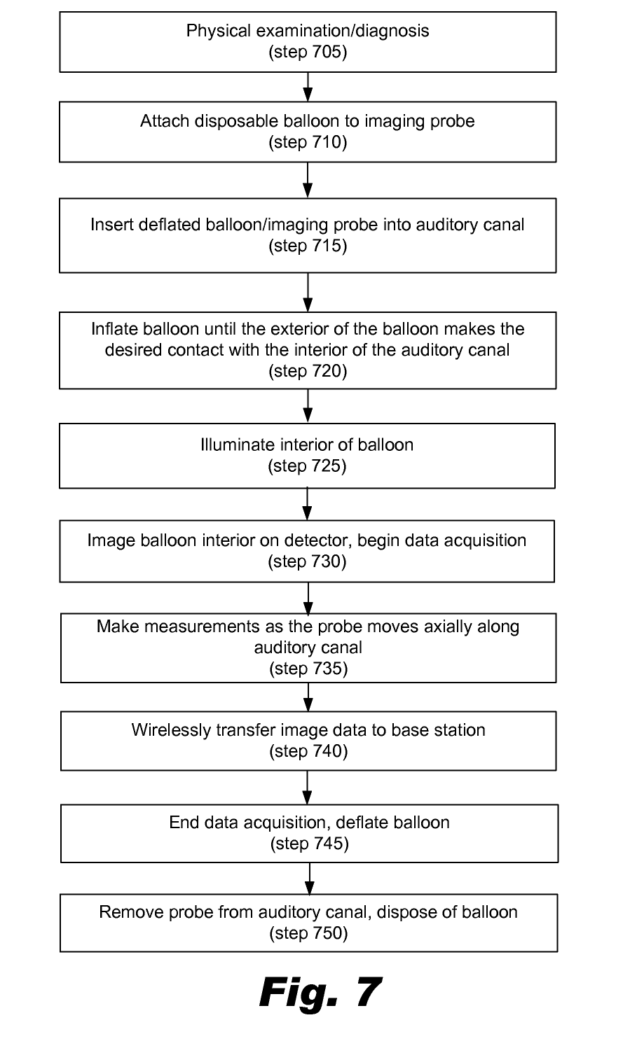

FIG. 7 is a flowchart showing one illustrative method for acquiring data from an intra-ear camera. In a first step, a physician, audiologist or other healthcare professional makes a physical examination of the patient and makes a diagnosis that calls for making a measurement of the auditory canal of the patient (step 705).

To make this measurement, a disposable balloon is attached to the imaging probe (step 710) and the deflated balloon and imaging probe are inserted into the patient's auditory canal (step 715). Various other steps may be performed to ensure patient comfort and measurement accuracy. By way of example and not limitation, various procedures may be used to prepare the auditory canal prior to the making the measurement. These procedures may include irrigation or inserting material into the auditory canal to protect the tympanic membrane. Additionally, the flexible vent pipe may also be inserted into the auditory canal to allow trapped air to escape as the balloon is inflated.

The balloon is then inflated until the exterior of the balloon makes the desired contact with the interior of the auditory canal (step 720). If a flexible vent pipe has be used, the vent pipe may be removed following the inflation of the balloon. The interior of the balloon is then illuminated (step 725). The intra-ear camera then begins make measurements of the interior of the balloon. The image of the interior of the balloon is focused onto the image sensor and data acquisition begins (step 730).

The imaging probe is moved axially along the auditory canal (step 735) making successive measurements of the interior of the balloon. According to one exemplary embodiment, the intra-ear camera transfers the data wirelessly to a base station or other computing device. In alternative embodiments, the data is transferred through a cable to the base station. In another embodiment, the measurements may be stored in memory contained within the intra-ear camera until after the completion of the measurement.

According to one illustrative embodiment, the intra-ear camera will be operated by voice control command. In some situations, finger motion of button pushing on the handheld intra-ear camera may introduce undesirable shaking of the imaging probe, causing image quality problems. Additionally, it may be difficult to modify or update new function buttons once the design is complete. Using voice control of the intra-ear camera can provide flexibility to the developers and convenience for health care professionals.

At the conclusion of the measurement, the balloon is deflated (step 745). The probe and the balloon are removed from the auditory canal (step 750). According to one exemplary embodiment, the balloon is disposable. By using a new balloon for each measurement, the sterility and integrity of the balloon is ensured.

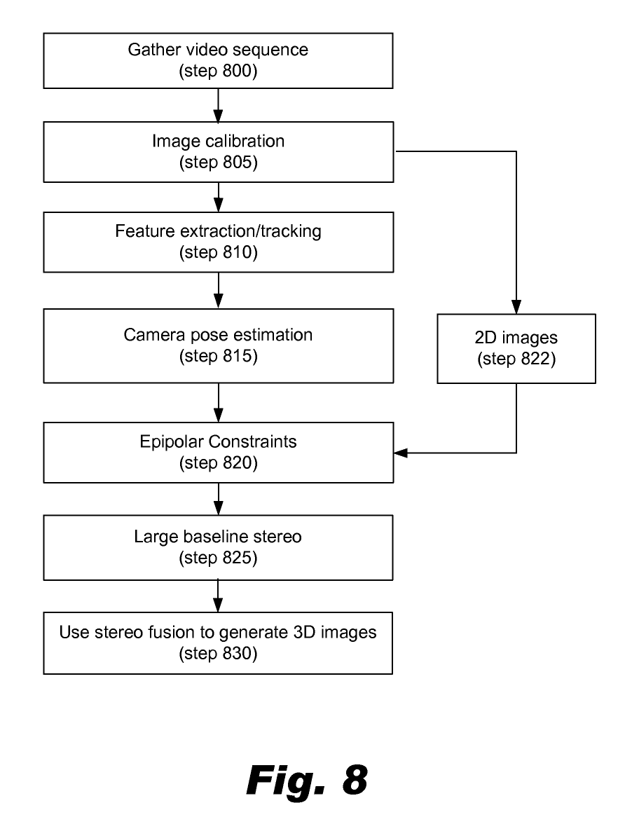

FIG. 8 is a flowchart showing one illustrative method for generating three-dimensional images from data acquired by an intra-ear camera. In a first step, a sequence of images is obtained (step 800). According to one exemplary embodiment, the sequence of images is a video sequence. The images are then calibrated (step 805) and features within the images are extracted and tracked through various images (step 810).

Camera pose estimation is then performed (step 820) and epipolar constraints are applied (step 820). Applying epipolar constraints involves translating the various views or image planes (see e.g., 505, 510) into some real world coordinate system. A calculation of the baseline distance between image pairs is calculated and large baseline distance pairs are selected (step 820). Stereo fusion, as described with respect to FIG. 5 and FIG. 6, is then performed to generate three-dimensional images.

In an alternative embodiment, following the image calibration (step 805), a number of two dimensional images (step 822) can be created. These two dimensional images can then be translated into a common reference coordinate system (step 820). The process then continues as previously described.

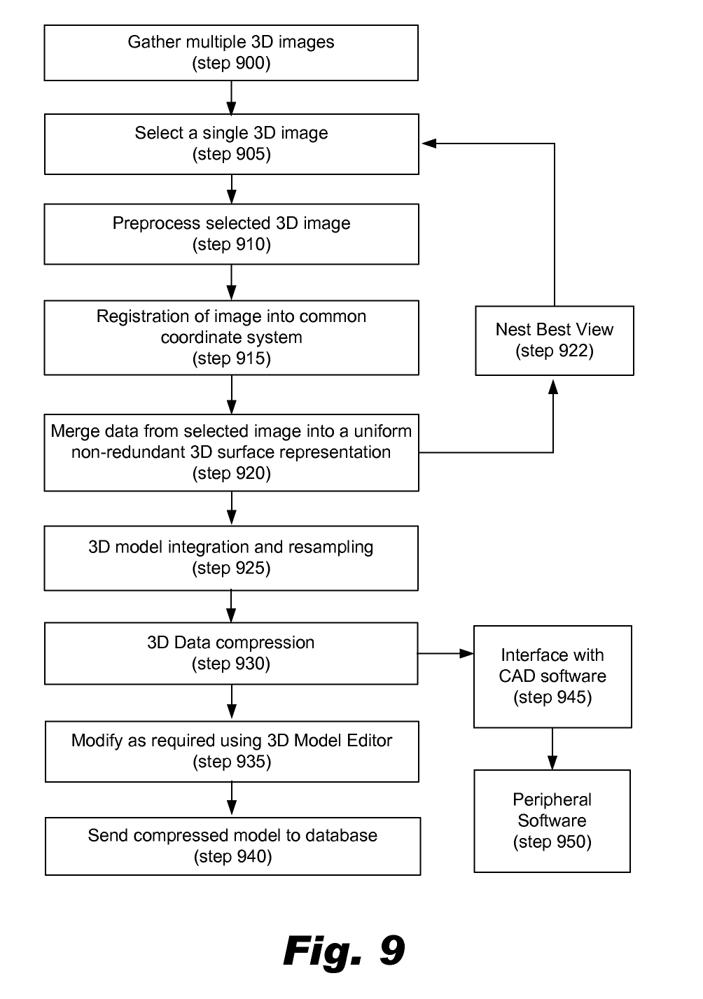

FIG. 9 is a flowchart showing one illustrative method for constructing and utilizing a three-dimensional model from three-dimensional images. The three-dimensional images may be produced by any number of methods, including the method described in FIG. 8 and accompanying text. In a first step, multiple three-dimensional images are gathered (step 900). A single three-dimensional image is selected (step 905) and preprocessed (step 910).

The image is then registered into a common coordinate system (step 915). This registration can be accomplished without prior knowledge or pre-calibration of the camera. According to one exemplary embodiment, the registration is accomplished using an iterative closest point (ICP) algorithm. Where two or more three-dimensional surfaces from the same object are captured at different directions with partial overlap in the images, the iterative closest point algorithm can be used to bring the images into the same coordinate system. The idea of the ICP algorithm is: given two sets of three-dimensional points representing two surfaces called P and X, find the rigid transformation as defined by rotation R and translation T, which minimizes the sum of Euclidean square distances between the corresponding points of P and X. The sum of all square distances gives the surface matching error:

$$e ( R , T ) = {\sum }_{k}^{N} {‖ ( {Rp}_{k} + T ) - {x}_{k} ‖}^{2} , {p}_{k} ∈ P and {x}_{k} ∈ X \qquad Eq . 3$$

Where:

e=error

R=rotation transformation component

T=translation transformation component

P=first surface

p=a given point on the first surface P

X=second surface

x=a given point on second surface X

By iteration, optimum R and T are found to minimize the error e(R, T). In each step of the iteration process, the closest point xₖ on X to pₖ on P is obtained by effective search such as k-D tree partitioning method.

According to one exemplary embodiment, the iterative closest point algorithm can be modified to use well tracked, two-dimensional feature points on two images to establish three-dimensional surface correspondences. This modification is shown as an optional step (step 822) in FIG. 8. This automatic registration can provide fast and reliable three-dimensional image registration, particularly when a feature rich surface is imaged, such as the interior of the balloon described herein.

This selected and registered image is then merged to form a uniform non-redundant three-dimensional surface representation (step 920). According to one embodiment, a mesh integration technique can be utilized to generate a single three-dimensional iso-surface model. The mesh integration technique can be of limited utility in cases where there are a large number of overlapping surfaces. In an alternative embodiment, a volumetric fusion approach can be used. A volumetric fusion approach is a general approach that can be suitable for a variety of circumstances, particularly where there is a large amount of data overlap between various surfaces.

The volumetric fusion approach is based on the idea of a marching cube, which creates a triangular mesh that will approximate the iso-surface. The marching cube algorithm first locates a surface in a cube of eight vertexes. Next, it assigns a value of 0 to vertices outside the surface and a value of 1 to vertices inside the surface. Triangles are generated based on the surface-cube intersection pattern. The algorithm then marches to the next cube and continues until a complete three-dimensional model is created by merging the various surfaces together.

Another image is selected (step 922) and the steps of preprocessing, registration and merging are repeated. Additional images can be selected, preprocessed, registered and merged until the supply of gathered three-dimensional images is exhausted or the three-dimensional surface representation is as accurate as desired. The method described with reference to steps 900 through 922 allows for an automatic and seamless registration and modeling of multiple three-dimensional images. The three-dimensional surface representations are integrated into a three-dimensional model and resampled to create a continuous non-redundant surface (step 925).

In many instances, the size of a three-dimensional dense model can be large. Transferring this large data set can cause problems for computer networks and data storage devices. The three-dimensional model can be compressed (step 930) by reducing the number of geometric primitives in the three-dimensional model while minimizing the difference between the reduced and original models. The three-dimensional distance between the original and compressed three-dimensional models is calculated to ensure the fidelity of the compressed model.

The model can then be modified, if required, using a three-dimensional model editor (step 935). The three-dimensional model can then be stored in a database (step 940). These digital models can then be retrieved, modified, and remade on demand, reducing the time required to create a replacement auditory device. In one embodiment, after compression of the three-dimensional model (step 930), the model can be sent to a CAD software application (step 945) and used to physically form either a model of the auditory canal or a custom device with a surface that conforms to the patient's auditory canal. In either case, peripheral software may be employed that controls automated fabrication equipment (step 950).

According to one exemplary embodiment, the majority of functions described in FIG. 8 and FIG. 9 will be incorporated into a single software package. Possible functions that would be excluded from the integrated software package include CAD software (step 945) and peripheral software (step 950). In one embodiment, the software package would be configured to automatically register free-form three-dimensional images of the auditory canal in 30 seconds, automatically merge the registered three-dimensional images into a complete three-dimensional ear model in 30 seconds, and automatically compress the three-dimensional model at a pre-defined rate.

The apparatus and methods described above could be used to make three dimensional models of a variety of confined spaces. By way of example and not limitation, these confined spaces could be other body cavities, the interior of mechanisms, containers, etc.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system for creating a three-dimensional model of a confined space comprising:
a balloon, said balloon having an exterior surface and an interior surface, said balloon being inflated to make contact between said exterior surface and a surface of said confined space, said interior surface having surface features;
a sensor, said sensor configured to make measurements of said interior surface of said balloon, said measurements being manipulated to form said three-dimensional model of said confined space.

2. The system of claim 1, wherein said sensor is an optical camera, said optical camera taking a sequence of images as said optical camera is moved within said balloon.

3. The system of claim 1, wherein said sensor further provides illumination of said interior surface.

4. The system of claim 3, wherein said sequence of images are 360 degree panoramic images.

5. The system of claim 1, wherein said confined space is an auditory canal, said balloon being inserted into said auditory canal and inflated to contact said auditory canal, said sensor being moved with said balloon to create a sequence of measurements.

6. The system of claim 1, further comprising a vent tube, said vent tube allowing air to escape said confined space as said balloon is inflated.

7. The system of claim 1, wherein said interior surface further comprises a calibration pattern configured to provide absolute scaling of said three-dimensional model.

8. The system of claim 1, wherein said sensor further comprises an integrated air pump, said integrated air pump providing pressurized air into said balloon.

9. The system of claim 1, wherein said balloon is disposable and replaceable.

10. A system creation of a three-dimensional model of a human auditory canal comprising:
a disposable balloon, said disposable balloon having an exterior surface and an interior surface, said disposable balloon being inflated to make contact between said exterior surface and a surface of said human auditory canal, said interior surface having surface features and a non-compliant scaling pattern, said non-compliant scaling pattern being configured to provide absolute scaling of said three dimensional model;
an intra-ear camera, said intra-ear camera being configured to make a sequence of panoramic images of said interior surface of said disposable balloon, said sequence of panoramic images being manipulated to form said three-dimensional model of said human auditory canal; said intra-ear camera further providing pressurized air to inflate said disposable balloon and an integral light source configured to illuminate said interior surface of said disposable balloon;
a flexible vent tube, said flexible vent tube allowing air to escape said human auditory canal as said balloon is inflated.

11. A method of creating a three-dimensional model of a confined space comprising:
making a series of 360 degree panoramic images of said confined space using a single moving camera;
manipulating said 360 degree panoramic images to create said three-dimensional model.

12. The method of claim 11, wherein said series of 360 degree panoramic images are divided into large baseline pairs, said large baseline pairs being used to estimate a position of said single moving camera and three dimensional locations of tracked features imaged by said large baseline pairs.

13. The method of claim 12, wherein said position of said single moving camera and said three dimensional location of said tracked features are estimated using a sum of squared difference technique.

14. The method of claim 13, wherein said sum of squared difference technique comprises calculating a sum of squared differences for multiple large baseline pairs and adding said sum of squared differences to create a single measure with reduced error.

15. The method of claim 11, wherein said making said series of 360 degree panoramic images comprises:
inflating a balloon inside of an auditory canal, said balloon having an interior surface and an exterior surface, said exterior surface making contact with said auditory canal and said interior surface comprising a plurality of features;
acquiring said series of 360 degree panoramic images by moving an intra-ear camera within said balloon.

16. The method of claim 11, wherein said manipulating said 360 degree panoramic images to create said three-dimensional model comprises:
using stereo fusion of said 360 degree panoramic images to generate said three-dimensional images;
registering said three-dimensional images into a common coordinate system; and
merging said three-dimensional images into a three dimensional surface.

17. The method of claim 16, wherein said using stereo fusion of said 360 degree panoramic images to generate said three-dimensional images comprises:
calibrating said 360 degree panoramic images;
extracting tracked features from said 360 degree panoramic images;
applying epipolar constraints;
pairing said 360 degree panoramic images into large baseline pairs; and
calculating a three-dimensional location and orientation of said single moving camera and dimensional location of said tracked features.

18. The method of claim 16, wherein merging said three-dimensional images into a three dimensional surface comprises volumetric fusion using a marching cubes technique.

19. The method of claim 11, further comprising:
compressing to create a compressed three dimensional model;
verifying accuracy of said compressed three-dimensional model; and
saving said compressed three dimensional model to database.

20. The method of claim 19, further comprising electronically communicating said three-dimensional model to a computer aided manufacturing facility for fabrication.
